(19) United States
(12) Patent Application Publication
(10) Pub. No.: US 2004/0036061 A1
(43) Pub. Date: Feb. 26, 2004

(54) Activated flame retardants and their applications

(76) Inventors: Michael S. Rhodes, Bronx, NY (US); Leonid Izrailev, Brooklyn, NY (US); Jason Tuerack, Jericho, NY (US); Philip S. Rhodes, Teaneck, NJ (US)

Correspondence Address: PILLSBURY WINTHROP, LLP, P.O. BOX 10500, MCLEAN, VA, 22102, US

(21) Appl. No.: 10/447,270

(22) Filed: May 29, 2003

Related U.S. Application Data
(63) Continuation-in-part of application No. 10/200,036, filed on Jul. 22, 2002.

(51) Int. Cl. C09K 21/00

(52) U.S. Cl. 252/606; 252/609

(57) ABSTRACT

The present invention relates to a method of enhancing the flame retardancy of nitrogenous phosphorus and/or sulfonate flame retardants, the enhanced (or activated) nitrogenous phosphorus and/or sulfonate flame retardants and their applications. The activated flame retardants are activated with either a char forming catalyst, a phase transfer catalyst or both.

### CROSS REFERENCE TO RELATED APPLICATION

This application is a continuation-in-part of U.S. Ser. No. 10/200,036, filed Jul. 22, 2002, which is incorporated herein, in its entirety, by reference.

### FIELD OF THE INVENTION

The present invention relates to a method of enhancing the flame retardancy of flame retardants, the enhanced (or activated) flame retardants and their applications. The activated flame retardants provide enhanced flame retardancy to virtually a limitless number and types of applications. For example, the activated flame retardants provide improved flame retardancy in polymers (including thermosetting, thermoplastic, polymer matrices, mixtures of polymers, copolymer, terpolymers, etc. . . . ) coatings, paints, films, resins, binders, fibers and articles formed from the same.

### BACKGROUND OF THE INVENTION

Several solutions are known in the art to reduce or eliminate the combustibility of polymers. Intumescent materials have been used for over forty years in industry. One of the first commercial intumescent agents used to provide fire protection by means of char formation was para nitro analine ortho sulfonic acid ammonium salt. Currently, the more common intumescent agents are generally constituted by the polymer of the system and at least three main additives: an essentially phosphorus-containing additive whose purpose is of forming, during the combustion, an impermeable, semi-solid vitreous layer, essentially constituted by polyphosphoric acid, and of activating the process of formation of intumescence; a second additive, containing nitrogen, which performs the functions of a foaming agent; and a third, carbon-containing additive, which acts as a carbon donor to allow an insulating cellular carbonaceous layer (“char”) to be formed between the polymer and the flame. Phosphates that release phosphoric acid at high temperature are frequently employed.

Examples of intumescent formulations of this type include those reported by the following patents: U.S. Pat. No. 3,810,862 (Phillips Petroleum Co.) based on melamine, pentaerythritol and ammonium polyphosphate; U.S. Pat. No. 4,727,102 (Vamp S.r.1.), based on melamine cyanurate, a hydroxyalkyl derivative of isocyanuric acid and ammonium polyphosphate; U.S. Pat. No. 6,015,510 (E. I. du Pont de Nemours and Company) based on melamine pyrophosphate and other conventional components; and by published patent application WO 85/05626 (Plascoat U.K. Limited), on the basis of various phosphorus and nitrogen compounds among which, in particular, a combination of melamine phosphate pentaerythritol and ammonium polyphosphate has to be cited.

In more recent formulations, together with the use of an organic or inorganic phosphorus compound a nitrogen-containing organic compound was used, generally consisting of an amino plastic resin obtained by condensation of urea, melamine or dicyandiamide with formaldehyde.

Examples of formulations containing two additives are those reported in the following patents: U.S. Pat. No. 4,504,610 (Montedison S.p.A.) based on oligomeric derivatives of 1,3,5-triazine and ammonium polyphosphate; and European Pat. No. 14463 (Montedison S.p.A.) based on organic compounds selected from among benzylguanamine and reaction products between aldehydes and several nitrogenous cyclic compounds, in particular benzylguanamine-formaldehyde copolymers, and ammonium polyphosphate.

Self-extinguishing compositions can also be obtained by using single-component additives, which contain in their organic molecule both nitrogen and phosphorus atoms, as disclosed in U.S. Pat. No. 4,201,705 (Borg-Wagner Corp.).

These intumescent flame retardant systems endow the polymers, which contain them, with the property of forming a carbonaceous residue when they undergo a fire, or are exposed to high temperatures. The present invention provides a method for of improving present and future nitrogenous phosphorus and/or sulfonate flame retardants. The activated flame retardants of the present invention provide one or more of the following advantages: improved char yield (includes faster generation of char and/or higher quantity of char), char density, self-extinguishing characteristics, thermal insulation (upon activation), and/or lower smoke emissions to the composition.

### SUMMARY OF THE INVENTION

The present invention provides a method of forming an activated nitrogenous phosphate and/or nitrogenous sulfonate flame retardant, having enhanced flame retardancy, by forming the nitrogenous phosphate and/or sulfonate component in the presence of a char forming catalyst and/or a phase transfer catalyst.

A further aspect of the present invention is an activated flame retardant comprising at least one nitrogenous phosphorus and/or sulfonate and at least one activator. An activator includes a char forming catalyst and/or a phase transfer catalyst.

Another aspect of the present invention provide an article having improved flame retardancy by the incorporation of an activated flame retardant.

### DETAILED DESCRIPTION OF THE INVENTION

In this application, the following terms will be understood to have the following meaning:

“activated flame retardant” means a flame retardant that provides improved flame retardancy, for example as measured by the Char Yield Value test discussed herein, with the incorporation of at least one activator, char forming catalyst and/or phase transfer catalyst, of the present invention than without an activator. Preferably, the activator is present in the activated flame retardant in a minor amount, for example less than 5 wt. %, or even less than 2 wt. % and preferably between 0.01 to 1.8 wt. %;

“halogen-free” means essentially free of halogens [i.e., contains less than 0.25 percent (preferably, less than 0.1 percent; more preferably, less than 0.01 percent)] by weight halogen calculated on an elemental basis as Cl, F, etc., based on the total weight of the flame retardant;

“hetero” refers to a component or compound comprising in addition to carbon and hydrogen atoms another type of atom (preferably oxygen, nitrogen, or sulfur atoms);

“metal-free” means essentially free of metals [i.e., contains less than 0.25 percent (preferably, less than 0.1 percent; more preferably, less than 0.01 percent)] by weight metal calculated on an elemental basis, based on the total weight of the flame retardant; and

“intumescent” refers to a material which expands upon heating above about 100° C., preferably above 190° C. or even 250° C., although the temperature at which a particular intumescent material intumesces is dependent on the composition of that material.

The activated flame retardants of the present invention may be used in the same applications as “unactivated” flame retardants are presently used or would be used. The employment of the activated flame retardants impart enhanced flame retardancy. Specifically, the activated flame retardant imparts improved char yield (includes faster generation of char and/or higher quantity of char), char density, self-extinguishing characteristics, thermal insulation (upon activation), and/or lower smoke emissions to the composition. In addition, the preferred flame retardant of the present invention are those that are halogen-free and/or metal-free which impart known benefits to systems beyond the flame retardancy benefits.

As a consequence, the activated flame retardants may be employed to impart an increased flame retardancy or employed in lesser (loadings) amounts to impart comparable flame retardancy. The type and loading levels of the activated flame retardant in a particular system is dependent on the specific design criteria. The loading levels of the activated flame retardant may be for example as low as 1, 5, or 8 wt. % and as high as 20, 30 or even 50 wt. %, relative to the total weight of the system.

Typical systems in which the activated flame retardant may be employed include compositions comprising synthetic materials and/or polymers including epoxies, polyamides (including nylon 6,6, and nylon 4,6), polyesters, polycarbonates, polyacrylates, polyethers, polyolefins, polyurethanes, derivatives of these polymers, copolymers, mixtures of these polymers, and mixtures comprising these polymers with other components. Suitable thermoplastic polymers that may be incorporated into such compositions include, for example, olefinic polymers or copolymers, linear polyesters, unsaturated polyesters, poly vinylchlorides, polyurethanes, acrylonitrile-styrene copolymers (SAN) acrylonitrile-butadiene-styrene terpolymers (ABS), and SBR rubbers and thermosetting polymers include rubbers, polyester, polyalkyds, polyurethanes and epoxies.

Compositions employing the activated flame retardants of the present invention may be used in a variety of applications including, for example, the formation of articles, components, coatings, binders, paints, fibers, emulsions (including vinyl emulsions), adhesives, films, casings, construction materials, rubber or rubberized components, cookware, medical devices, composites, aeronautic components, putties, sealants, caulks, and fire barrier materials.

Since the present invention possesses the remarkable ability to enhance the flame retardancy of many common materials such as plastics, fibers, and natural materials, the present invention will have the advantage of enhancing the flame retardancy of articles, objects or compositions comprised of these materials. A useful application for these materials can be found in materials and objects used in the construction or housing materials market.

The activated flame retardant may be incorporated in any convenient place within the prefabricated unit, for example it may be incorporated within polymeric materials that comprise the insulation, veneer, or adhesives of the unit. Alternatively, the activated flame retardant may be applied directly to coat or penetrate a layer or element of such a unit, for example, by spraying or soaking.

The activated flame retardant of the present invention may be incorporated into or applied on or to a board comprising lignocellulosic, cellulosic, or composite materials. Lignocellulosic boards that may be produced by the present invention include particle board, Medium Density Fiberboard (MDF) agrifiber board (such as straw board or bagasse, etc.), oriented strand board and the like. These boards are generally prepared by coating or contacting lignocellulosic particles with a binder resin to form a lignocellulosic mixture, optionally adding other additives including parting agents or wood preservatives and compressing the mixture at elevated temperatures and pressures for a time sufficient to make commercially useful articles such as boards.

Other suitable composite boards which may be treated by the flame retardants of the present invention may comprise gypsum (e.g., calcium sulfate hemihydrate or calcium sulfate dihydrate) or gypsum mixed with reinforcement materials and fillers.

The activated flame retardant compositions may be incorporated into a prefabricated building unit used in the construction of a building or a wall. Such prefabricated units are described, for example, in U.S. Pat. Nos. 5,642,594; 5,715,637; and 6,240,691, the entire disclosures of which are incorporated herein by reference.

The holes or cutouts in building materials (e.g., drywall) for electrical, telephone, communications or other similar type interfaces, usually located within a wall (hereinafter “interfaces”). provide vulnerable areas for fire ingress and thus compromise the integrity of the building's fire retardancy. The present invention provides cover plates for enclosing interfaces with enhanced flame retardant properties.

The compositions of the present invention can be formed into a cover plate. Cover plates are articles installed over interfaces, for example, electrical, telephone, communications or other similar type interface. In some embodiments, the cover plates will lie flush with, or on the surface of, a wall in which the interface is located. Non-limiting examples of such cover plates include plates which fit over electrical outlets or switches, covers for phone jacks, information portals (e.g., ethernet jacks), thermostat covers and the like. In this embodiment, the present invention provides improved flame retardancy integrity to a structure by affording flame resistance to the surface of a cover plate.

The flame retardancy of a fiber, yam, fabric, or products made from a fiber, yarn, or fabric, is increased or improved by the incorporation, treatment, and/or coating of the activated flame retardants described herein. The fibers, yarns, or fabrics may be made from either a natural product (e.g., cotton, flax, linen, wool, or hemp) or a synthetic product, such as a polymer, e.g., polyamides, nylons, polyesters, polyalkanes, polyethers, and polyacrylates or fluorinated or perfluorinated polyalkanes, polyolefins (e.g., polyethylene), polyacrylates, polyethers, polyamides and multi-polymers (i.e., copolymers, terpolymers, etc.) and combinations thereof. As a result, the flame retardancy of a product or article made from these materials (e.g., carpets, fabrics, upholstery, clothing or other textiles, camping and other outdoor water resistant textiles, simulated leathers, rope, and the like) may be improved by the present invention.

Preferably the synthetic fibers used in the present invention are nylons, such as nylon 6,6; nylon 6; nylon 6,9; nylon 6,10; nylon 6IA; and nylon 6TA. Also suitable are copolymers, for example, nylon 6,6 and nylon 6; nylon 6,6 and nylon 6,9; nylon 6,6 and nylon 6,10; nylon 6,6 and nylon 6IA; and terpolymers, for example, nylon 6,6, nylon 6,9, and nylon 6TA; nylon 6,6, nylon 6,10, and nylon 6TA; and nylon 6,6, nylon 6TA, and nylon 6IA.

The flame retardants of the present invention may also be incorporated into expoxy-resins to impart improved flame retardancy. Such epoxy resins are useful, for example, in coating compositions, semiconductor encapsulants, adhesives, and as noise and vibration attenuation materials. Generally, epoxy resins are either of the ether or ester types, both of which are suitable for use in the present invention.

The flame retardants of the present invention may also be incorporated into electrical tapes that may be used for wire splicing, insulation, protective jacketing, wire harnessing, and other electrical applications. Such tapes may be of any suitable type and construction as recognized by one of skill in the art. Typically, these tapes comprise at least one polymer or polymer layer from polyvinylchloride, polypropylene or polyethylene.

The flame retardants of the present invention also provide insulation for conductors (e.g., electrical and/or light conductors) with improved flame retardancy. Insulation is understood to include nonconductive or semiconductive sheathing, covering or coating surrounding the conductor. For example, jacketing is a type of insulation that surrounds one or more insulated conductors.

Such insulators may be formed from any material suitable for this purpose. For example, polyolefins preferably, polyethylene or polypropylene. Construction of the insulated or jacketed conductors of the present invention may be by any conventional technique (e.g. extrusion) and the insulation or jacketing material may further comprise optional additives, e.g., initiators, stabilizers, plasticizers, and/or dyes.

Generally, the activated flame retardants may be added into a composition by any conventional technique including the dry mixing of all or a number of components in a tumble mixer, followed by melting in a melt mixer, for example a Brabender mixer, and/or an extruder, by molding the components and the polymer simultaneously, by blending all the components together in powder form and thereafter, forming the desired product. The activated flame retardants may also be incorporated into a system by introducing the activated flame retardant during the reaction phase of one or more of the components of the composition. It may be that incorporating the activated flame retardant in with the monomers prior to the formation of the polymer may further enhance the effectiveness of the activated flame retardant.

The activated flame retardant comprises a nitrogenous phosphate or sulfonate component formed in the presence of an activator. The nitrogenous phosphate or sulfonate component may be formed using any of the conventional techniques with the activator being introduced at least in part prior to the formation of the final product. For example, the activator may be introduced either in total or in part with one or more of the nitrogen containing compounds and then have the phosphorus or sulfur containing compound reacted in. These nitrogenous phosphate or sulfonate components may also be formed by introducing parts of one or more of the reactants in steps. For example, a portion of the total amount of the nitrogen containing reactant may be added to a portion of the activator followed by a portion of the phosphorus or sulfur containing reactant and then repeated in any order and in as many steps as desired to obtain the final activated flame retardant.

The selection of the nitrogen containing reactant and the phosphorus or sulfur containing reactant used is a matter of design choice. Suitable reactants include those known for use in forming nitrogenous phosphate or sulfonate flame retardants, for example ammonium phosphate, ammonium pyrophosphate, ammonium polyphosphate, ethylene-diamine phosphate, piperazine phosphate, piperazine-pyrophosphate, melamine phosphate, dimelamine phosphate, melamine pyrophosphate, guanidine phosphate, dicyanodiamide phosphate urea phosphate, ammonium sulfonate, ammonium polysulfonate, ethylenediamine sulfonate, dimelamine suflonate, quanidine sulfonate, and dicyanodiamide sulfonate. For example, suitable nitrogen containing reactants include ammonium, alkyleneamines (including diamines), triazine, melamine, melam, melem, melon, ammeline, ammelide, 2-ureidomelamine, acetoguanamine, benzoguanamine, quanidine, dicyanodiamide, diamine phenyltriazine or mixtures hereof. Preferred nitrogen containing reactants include melamine, ammonium, and ethylene diamine. Examples of suitable phosphorus or sulfur containing reactants include phosphoric acid and sulfonic acid.

The activator is a component that enhances the performance of the nitrogenous phosphate and/or sulfonate component and preferably is a char forming catalyst or a phase transfer agent or a combination of both. The activator can be present in the flame retardant in any amount that provides the acceptable enhanced flame retardancy, for example up to 5, 8 or 10 wt. % and as little as 0.01, 0.1 and 0.2 wt. %. It is preferred to use both a char forming catalyst and a phase transfer catalyst together these may be present in the flame retardant in an amount between 0.1, preferably 0.3, and 3.0, preferably 2.5 wt. %, based on the total weight of the flame retardant.

Although not wanting to be held to any particular theory, it has been said that the char forming catalyst may act, at the time of decomposition of part of the system, to grab onto decomposing molecules thereby minimize the production of low molecular weight components and enabling rapid development of char. It has been similarly theorized that this recombinant process, that is aided by the char forming catalyst, mimics the recombinant role that the helical DNA plays in nature. Consequently, exemplary char forming catalysts of the present invention include multi-cyclic compounds having at least one reactive group in each of at least two rings, wherein the rings are joined together by atoms common to both rings. These may include spiro-compounds comprising at least two heterocyclic ring structures joined by at least one carbon atom common to both rings.

Preferred char forming catalyst include spiro-compounds represented by the following formula I:

R₂-R₁-(R₀)m-R₁-R₂ I

wherein

m represents a number between 1 and 8, for example less than 3 or less than 2;

R₀—independently represent a di-, tri-, or quad-valent radical comprising two independently substituted or unsubstituted, saturated or unsaturated heterocyclic ring structures joined by at least one common carbon atom and preferably no more than two, for example one, carbon atoms common to the heterocyclic ring structures;

R₁—independently represents a bond; or a substituted or unsubstituted, saturated or unsaturated hydrocarbyl or heterocarbyl linking group, preferably a C1-C6 alkyl linking group, for example a C3 alkyl; and

R₂—independently represents a terminal group, preferably a terminal amine for example a primary amine.

Exemplary compounds include those wherein the heterocyclic ring structure comprises at least two hetero atoms in at least two heterocyclic ring structures, and/or R₀ independently represents a divalent radical, preferably with at least one, for example two (including two adjacent), heterocyclic ring structures being 6-member. These compounds may also include those wherein the hetero atom in the heterocyclic rings is predominately oxygen.

The preferred char catalyst includes those having a molecular weight of at least 180, preferably at least 200 and/or a flash point of greater than 200° C. A preferred char forming catalyst includes derivatives of a tetraoxaspiro undecane, for example amine derivatives, for example 2,4,8,10-tetraoxaspiro-5,5-undecane-3,9-dipropamine. The char forming catalyst component may also include adducts, for example amine adducts, nitrile (include 2-propenenitrile) and/or oxirane (including butoxymethyl oxirane) adducts.

The phase transfer agent may be any component known for such purpose. Suitable phase transfer catalyst include tetrahydrocarbyl ammonium salts, for example tetramethyl, tetraethyl, tetrapropyl, tetralkyl, and/or aryltrialkyl ammonium salt wherein the salt is a bromide, chloride, hydroxide and/or hydrogen sulfate ammonium salt. Preferably, the phase transfer catalyst includes phosphate esters, tetraethylammonium bromide, tetraethylammonium hydroxide, tetrapropylammonium bromide, tetrabutyl ammonium bromide, tetrabutyl ammonium hydroxide, tetrabutyl ammonium hydrogen sulfate and/or benzyltriethyl ammonium chloride.

Compositions of the present invention may additionally comprise conventional additives such as reinforcing fillers, pigments such as carbon black, and titanium dioxide, dyes, ultraviolet stabilizers, plasticizers, fungicides, extenders, waxes, antioxidants, and the like, in amounts known to those skilled in the art.

Other useful fillers include fumed silica, calcium and magnesium carbonates, calcium and barium sulfates, aluminum silicates, and the like, which may be included in small amounts, such that they do not interfere with the physical properties required.

### EXAMPLES

Objects and advantages of this invention are further illustrated by the following examples, but particular materials and amounts thereof recited in these examples, as well as conditions and details, should not be construed to unduly limit this invention.

Test Method: Char Yield Value

Char yield value for the coating samples was measured by pouring about 10 grams of the coating into an aluminum lab pan an allowing the coating to cure either overnight or in an oven for approximately 1 hour @ 80° C. After curing, the coated substrate was weighted (initial weight, not inclusive of the lab pan weight) and then placed in a muffle furnace, maintained at 1000° C., overnight. The charred, coated substrate was allowed to cool and weighted again (final weight, not inclusive of the lab pan weight).

Char Yield Value=(final weight/initial weight)×100.

The higher the char yield value, the better the flame retardancy of the coating.

Glossary of Materials:

| | |
|---|---|
| BTEAC | Benzyltriethyl Ammonium Chloride |
| B-001 | 2,4,8,10 tetraoxaspiro (5,5) undecane-3,9-dipropanamine adduct |
| | with 2-propenenitrile commercially available from Ajinomoto, |
| | Inc. under the tradename YSE-CURE B-001 |
| B-002 | 2,4,8,10-tetraoxaspiro (5,5) undecane-3,9-dipropanamine with an |
| | amine adduct commercially available from Ajinomoto, Inc. under |
| | the tradename YSE-CURE B-002. |
| D-230 | Polyoxypropylenediamine commercially available from |
| | Huntsman Corp., under the tradename Jeffamine D-230. |
| Epoxy | Bisphenol A/Epichlorohydrin based epoxy resin commercially |
| | available from Shell under the tradename EPON 828. |
| Fyrol CEF | Tri(2-chloroethyl) phosphate commercially available from AKZO |
| | Nobel. |
| Fyrol DMMP | Dimethyl methylphosphonate commercially available from |
| | AKZO Nobel |
| NYAD | NYAD - Wollastonite is a naturally occurring mineral |
| | commercially available from NYCO Minerals Inc. |
| Paint 20 | vinyl acrylic exterior semi-gloss latex paint commercially |
| | available from Vista Paints |
| TBABr | Tetrabutylammonium Bromide |
| TBAHS | Tetrabutylammonium Hydrogen Sulfate |

### Example 1

### Preparation of Ammonium Polyphosphate Flame Retardant

To 900 grams of water, while under agitation, was added 240 grams ammonium and B-001, a char catalyst, in an amount such that the final, dried ammonium polyphosphate product consisted of the wt. % set forth in Table 1 below. The mixture was warmed to 170° F. and while maintaining temperature phosphoric acid was slowly added until a pH of 7.0 was reached. The mixture was cooled, filtered, dried and ground to recover the flame retardant.

Char Yield Value Testing

The flame retardancy of the various ammonium polyphosphate flame retardants was established by preparing coating samples by mixing the various flame retardants into a clear epoxy resin and a latex paint composition formed from the components as set forth in Tables 1-A&C, respectively, and testing for the char yield value in accordance with the method set forth herein. The results are reported in Tables 1-B&D, respectively.

TABLE 1-A
CLEAR EPOXY RESIN

| Component | Wt. % |
|---|---|
| Component A | |
| Epoxy | 55 |
| Fyrol DMMP | 13 |
| Flame Retardant | 32 |
| Component B | |
| B-001 | 64.5 |
| D-230 | 35.5 |
| Ratio Comp. A:Comp. B | 1:0.26 |

TABLE 1-B
Char Yield Value of Ammonium Polyphosphate Flame Retardant

| | Amount of Char Catalyst Present in Flame Retardant | | | | |
|---|---|---|---|---|---|
| Type of Char Catalyst | Control | 0.1 wt. % | 0.2 wt. % | 0.5 wt. % | 1.0 wt. % |
| B-001 | 30 | 46 | 48 | 50 | 50 |

Table Note: Control is the epoxy resin composition with a flame retardant having 0 wt. % char catalyst.

TABLE 1-C
LATEX PAINT

| Component | Wt. % |
|---|---|
| Paint-20 | 64 |
| Melamine | 10 |
| Pentaerythritol | 3 |
| Blowing Agent | 3 |
| Flame | 20 |
| Retardant | |

TABLE 1-D
Char Yield Value of Ammonium Polyphosphate Flame Retardant

| | Amount of Char Catalyst Present in Flame Retardant | | | | |
|---|---|---|---|---|---|
| Type of Char Catalyst | Control | 0.1 wt. % | 0.2 wt. % | 0.5 wt. % | 1.0 wt. % |
| B-002 | 30 | 42 | 45 | 46 | 47 |

Table Note: Control is the latex paint composition with a flame retardant having 0 wt. % char catalyst.

### Example 2

### Preparation of Melamine Pyrophosphate Flame Retardant

1200 grams of water was warmed to 130° F. To this, while being agitated, was added 100 grams of melamine (2,4,6-triamine-1,3,5-triazine) and a char and/or phase transfer catalyst as set forth in Table 2-B below. The mixture was then warmed to 150° F. and 104.5 grams of tetrasodium pyrophosphate was added. The mixture was heated to 170° F. and the slow addition of 200 grams of twenty degree Baume muriatic acid was started. Warming was continued until to 200° F., at which time cooling is started. When cooled to 70° F., the mixture was filtered, dried and ground to recover the flame retardant.

Char Yield Value Testing

The flame retardancy of the various ammonium pyrophosphate flame retardants was established by preparing epoxy resin coating samples by mixing the various flame retardants into the epoxy resin composition formed from the components as set forth in Table 2-A, and testing for the char yield value in accordance with the method set forth herein. The results are reported in Table 2-B.

TABLE 2-A
EPOXY RESIN

| Component | Wt. % |
|---|---|
| Component A | |
| Epoxy | 45 |
| Fyrol CEF | 12.7 |
| Aluminum Trihydrate | 12.7 |
| NYAD | 1.6 |
| Titanium Dioxide | 3 |
| Flame Retardant | 25 |
| Component B | |
| B-001 | 100 |
| Ratio Comp. A:Comp. B | 4:1 |

TABLE 2-B
Char Yield Value of Melamine Pyrophosphate Flame Retardant

| Type of Char and/or | | | | | |
|---|---|---|---|---|---|
| Phase Transfer | Amount of Catalyst Present in Flame Retardant | | | | |
| Catalyst | Control | 0.1 wt. % | 0.2 wt. % | 0.5 wt. % | 1.0 wt. % |
| B-001 | 34 | 50 | 52 | 55 | 57 |
| B-002 | 35 | 43 | 45 | 48 | 49 |
| TBABr | 30 | 37 | 39 | 41 | 43 |
| TBAHS | 30 | 38 | 43 | 45 | 47 |
| B-001 | 30 | 54 | 63 | 70 | 72 |
| (TBAHS @ 0.5 | | | | | |
| wt. %) | | | | | |
| TBAHS | 30 | 56 | 61 | 70 | 71 |
| (B-001 @ 0.5 wt. %) | | | | | |
| BTEAC | 30 | 42 | 52 | 61 | 68 |
| (B-001 @ 0.5 wt. %) | | | | | |

Table Note: Control is the epoxy resin composition with a flame retardant having 0 wt. % char catalyst.

### Example 3

### Preparation of Ethylene Diamine Flame Retardant

To 900 grams of water, while under agitation, was added 240 grams of ethylene diamine and TBAHS, a phase transfer catalyst, as set forth in Table 3 below. The mixture was warmed to 170° F. and, while maintaining temperature, phosphoric acid was slowly added until a pH of 7.0 was reached. The mixture was cooled, filtered, dried and ground to recover the flame retardant.

Char Yield Value Testing

The flame retardancy of the various ethylene diamine phosphate flame retardants was established by preparing epoxy resin coating samples by mixing the various flame retardants into the epoxy resin composition as set forth in Example 2, Table 2-A, and testing for the char yield value in accordance with the method set forth herein. The results are reported in Table 3.

TABLE 3
Char Yield Value of Ethylene Diamine Phosphate Flame Retardant

| Type of | Amount of Phase Transfer | | | | |
|---|---|---|---|---|---|
| Phase Transfer | Catalyst Present in Flame Retardant | | | | |
| Catalyst | Control | 0.1 wt. % | 0.2 wt. % | 0.5 wt. % | 1.0 wt. % |
| TBAHS | 30 | 44 | 47 | 50 | 53 |

Table Note: Control is the epoxy resin composition with a flame retardant having 0 wt. % char catalyst.

### Example 4

### Preparation of Ethylene Diamine Phosphate/Melamine Phosphate

To 900 grams of water, while under agitation, was added 180 grams of ethylene diamine, 60 grams of melamine and char and/or phase transfer catalysts as set forth in Table 4 below. The mixture was warmed to 170° F. and, while maintaining temperature, phosphoric acid was slowly added until a pH of 7.0 was reached. The mixture was cooled, filtered, dried and ground to recover the flame retardant.

Char Yield Value Testing

The flame retardancy of the various ethylene diamine phosphate/melamine phosphate flame retardants was established by preparing epoxy resin coating samples by mixing the various flame retardants into the epoxy resin composition as set forth in Example 2, Table 2-A, or polyurethane coating samples by mixing the various flame retardants into Durbak 16, a polyurethane coating commercially available from Cote-L Industries, and testing for the char yield value in accordance with the method set forth herein. The results are reported in Table 4.

TABLE 4
Char Yield Value of Ethylene Diamine Phosphate/Melamine
Phosphate Flame Retardant

| Type | | | | | |
|---|---|---|---|---|---|
| of Char and | | | | | |
| Phase Transfer | Amount of Catalyst Present in Flame Retardant | | | | |
| Catalyst | Control | 0.1 wt. % | 0.2 wt. % | 0.5 wt. % | 1.0 wt. % |
| TBABr | 30 | 51 | 59 | 66 | 72 |
| (B-001 @ | | | | | |
| 0.5 wt %) | | | | | |
| B-001 | 30 | 50 | 56 | 69 | 71 |
| (TBABr @ | | | | | |
| 0.5 wt. %) | | | | | |
| BTEAC | 30 | 44 | 47 | 50 | 53 |

Table Note: Control is the epoxy resin composition with a flame retardant having 0 wt. % char catalyst.

Various modifications and alterations of this invention will become apparent to those skilled in the art without departing from the scope and spirit of this invention, and it should be understood that this invention is not to be unduly limited to the illustrative embodiments set forth herein.

What is claimed is:

1. An activated flame retardant comprising:
at least one nitrogenous phosphate and/or sulfonate component, and
at least one char forming catalyst and/or a phase transfer catalyst.

2. The flame retardant of claim 1, wherein the char forming catalyst includes a spiro-compound comprising at least two heterocyclic ring structures joined by at least one common carbon atom.

3. The flame retardant according to any one of claims 1-2, wherein the char forming catalyst spiro-compound is represented by the following formula I:
R₂-R₁-(R₀)m-R₁-R₂ (I)
wherein
m represents a number between 1 and 8;
R₀—independently represent a di-, tri-, or quad-valent radical comprising two independently substituted or unsubstituted, saturated or unsaturated heterocyclic ring structures joined by at least one common carbon atom;
R₁—independently represent a bond; or a substituted or unsubstituted, saturated or unsaturated hydrocarbyl or heterocarbyl linking group; and
R₂— independently represent a terminal group.

4. The flame retardant according to any one of claims 1-3, wherein the char forming catalyst comprises no more than two carbon atoms common to said at least two heterocyclic ring structures.

5. The flame retardant according to any one of claims 1-4, wherein the char forming catalyst comprises one carbon atom common to said at least two heterocyclic ring structures.

6. The flame retardant according to any one of claims 1-5, wherein the char forming catalyst comprises at least one oxygen, nitrogen, or sulfur atom in each of said at least two heterocyclic ring structures.

7. The flame retardant according to any one of claims 1-6, wherein the char forming catalyst comprises at least two hetero atoms in each of said at least two heterocyclic ring structures.

8. The flame retardant according to claim 3, wherein R₀ independently represents a divalent radical.

9. The flame retardant according to claim 3, wherein R₀ independently represent a divalent radical wherein at least one of the heterocyclic ring structures is a 6-member ring.

10. The flame retardant according to claim 3, wherein R₀ independently represents a divalent radical wherein at least two adjacent heterocyclic ring structures are 6-member rings.

11. The flame retardant according to claim 3, wherein R₀ independently represents a divalent radical wherein the hetero atoms in said at least two heterocyclic ring structures are predominately oxygen.

12. The flame retardant according to any one of claims 1-11, wherein the char forming catalyst comprises at least one terminal amine.

13. The flame retardant according to any one of claims 1-12, wherein the char forming catalyst comprises at least one primary amine.

14. The flame retardant according to any one of claims 1-13, wherein the char forming catalyst has a molecular weight of at least 180.

15. The flame retardant according to any one of claims 1-14, wherein the char forming catalyst has a flash point of greater than 200° C.

16. The flame retardant according to any one of claims 1-15, wherein the char forming catalyst comprises two heterocyclic rings.

17. The flame retardant according to any one of claims 1-16, wherein the char forming catalyst comprises two heterocyclic rings each comprising two hetero atoms.

18. The flame retardant according to any one of claims 1-17, wherein the char forming catalyst comprises two terminal amines.

19. The flame retardant according to any one of claims 3-18, wherein R₁ independently represents a substituted or unsubstituted, saturated hydrocarbyl linking group.

20. The flame retardant according to any one of claims 3-19, wherein R₁ independently represents a C₁-C₆ alkyl linking group.

21. The flame retardant according to any one of claims 3-20, wherein R₁ independently represents a C3 alkyl divalent linking group.

22. The flame retardant according to any one of claims 3-21, wherein R₂ independently represents an amine.

23. The flame retardant according to any one of claims 3-22, wherein R₂ independently represent a primary amine.

24. The flame retardant according to any one of claims 3-23, wherein m represents a number less than 3.

25. The flame retardant according to any one of claims 3-24, wherein at least two R₁ are the same and at least two R₂ are the same and m is 1.

26. The flame retardant according to any one of claims 1-25, wherein the phase transfer catalyst include tetrahydrocarbyl ammonium salts.

27. The flame retardant according to any one of claims 1-26, wherein the phase transfer catalyst includes a tetramethyl, tetraethyl, tetrapropyl, tetralkyl, and/or aryltrialkyl ammonium salt.

28. The flame retardant according to any one of claims 1-27, wherein the phase transfer catalyst includes a bromide, chloride, hydroxide and/or hydrogen sulfate ammonium salt.

29. The flame retardant according to any one of claims 1-28, wherein the phase transfer catalyst includes tetraethylammonium bromide, tetraethylammonium hydroxide, tetrapropylammonium bromide, tetrabutyl ammonium bromide, tetrabutyl ammonium hydroxide, tetrabutyl ammonium hydrogen sulfate and/or benzyltriethyl ammonium chloride.

30. The flame retardant according to any one of claims 1-29, wherein the flame retardant is halogen-free.

31. The flame retardant according to any one of claims 1-30, wherein the flame retardant is metal-free.

32. The flame retardant according to any one of claims 1-31, wherein the flame retardant comprises less than 5.0 wt. % of a char forming catalyst.

33. The flame retardant according to any one of claims 1-32, wherein the flame retardant comprises less than 2.0 wt. % of a char forming catalyst.

34. The flame retardant according to any one of claims 1-33, wherein the flame retardant comprises less than 2.0 wt. % of a phase transfer catalyst.

35. A method of forming a nitrogenous phosphate and/or sulfonate flame retardant comprising:
mixing an ammonium containing compound with at least one char forming catalyst and/or a phase transfer catalyst, and
reacting the mixture with a phosphate and/or sulfur containing compound.

36. The method of claim 35, wherein the ammonium containing compound is selected from ammonium, triazine, melamine, melam, melem, melon, ammeline, ammelide, 2-ureidomelamine, acetoguanamine, benzoguanamine, diamine phenyltriazine or mixtures hereof.

37. The method of claim 11, wherein the phosphate and/or sulfur containing compound is selected from phosphoric acid and/or sulfonic acid.

38. An article comprising the activated flame retardant according to any one of claims 1-34.

39. The article of claim 38 wherein the article is a coating, binder, paint, fiber, emulsion, adhesive, film, casing, article of construction, rubberized component, cookware, medical device, composite, aeronautic component, putty, sealant, caulk, or fire barrier material.

40. An article formed from the method according to any one of claims 35-37.

41. A cover plate comprising the activated flame retardant according to any one of claims 1-34.

42. The cover plate of claim 41 wherein said cover plate is an electrical outlet cover plate.

43. The cover plate of claim 41 wherein said cover plate is an electrical switch cover plate.

44. A substrate comprising an activated flame retardant according to any one of claims 1-34.

45. The substrate of claim 44 further comprising lignocellulosic material.

46. The substrate of claim 44 further comprising composite material.

47. The substrate of claim 44 wherein said substrate is a particle board.

48. The substrate of claim 44 wherein said substrate is a Medium Density Fiberboard.

49. The substrate of claim 44 further comprising gypsum.

50. A fiber incorporating, treated with and/or coated with the activated flame retardant according to any one of claims 1-34.

51. A yarn incorporating, treated with and/or coated with the flame retardant according to any one of claims 1-34.

52. A fabric incorporating, treated with and/or coated with the flame retardant according to any one of claims 1-34.

53. The fabric of claim 52 wherein said fabric is water repellant.

54. An epoxy resin comprising an activated flame retardant according to any one of claims 1-34.

55. An epoxy resin according to claim 54 further comprising polyglycidyl ethers of polycarboxylic acids.

56. The epoxy resin of claim 54 wherein the polyepoxide is obtained by reaction of epichlorohydrin with an aliphatic, cycloaliphatic or aromatic polycarboxylic acid.

57. The epoxy resin of claim 56 wherein said polycarboxylic acid is selected from oxalic acid, succinic acid, adipic acid, glutaric acid, phthalic acid, terephthalic acid, hexahydrophthalic acid, 2,6-naphthelenedicarboxylic acid and dimerized linolenic acid.

58. An electrical tape comprising an activated flame retardant according to anyone of claims 1-34.

59. A conductor insulator comprising an activated flame retardant according to anyone of claims 1-34.

60. A conductor jacket comprising an acitvated flame retardant according to anyone of claims 1-34.
